(19) United States
(12) Patent Application Publication
(10) Pub. No.: US 2005/0061788 A1
(43) Pub. Date: Mar. 24, 2005

(54) Laser beam machine

(76) Inventors: Yusuke Nagai, Tokyo (JP); Satoshi Kobayashi, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/938,724

(22) Filed: Sep. 13, 2004

(30) Foreign Application Priority Data
Sep. 18, 2003 (JP) 2003-325521

(51) Int. Cl. B23K 26/06

(52) U.S. Cl. 219/121.75; 219/121.83; 219/121.82

(57) ABSTRACT

A laser beam machine comprising a workpiece holding means for holding a workpiece and a laser beam application means comprising a condenser for applying a laser beam to the workpiece held on the workpiece holding means, wherein the machine further comprises thermostatic means for maintaining the temperature of a case for housing the condenser lenses of the condenser constant.

### FIELD OF THE INVENTION

The present invention relates to a laser beam machine for processing a workpiece such as a semiconductor wafer.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer and a circuit such as IC, LSI or the like is formed in each of the sectioned areas. Individual semiconductor chips are manufactured by cutting this semiconductor wafer along the streets to divide it into the circuit-formed areas. An optical device wafer in which gallium nitride-based compound semiconductors are laminated on the front surface of a sapphire substrate is also cut along dividing lines to be divided into individual optical devices such as light emitting diodes or laser diodes, which are widely used in electric equipment.

Cutting along the streets of the semiconductor wafer or optical device wafer is generally carried out by a cutting machine called “dicer”. This cutting machine comprises a chuck table for holding a workpiece such as a semiconductor wafer or optical device wafer, a cutting means for cutting the workpiece held on the chuck table, and a moving means for moving the chuck table and the cutting means relative to each other. The cutting means comprises a rotary spindle that is rotated at a high speed and a cutting blade mounted to the spindle. The cutting blade comprises a disk-like base and an annular cutting edge that is mounted to the side wall outer peripheral portion of the base and formed as thick as about 20 μm by fixing diamond abrasive grains having a diameter of about 3 μm to the base by electroforming.

Since a sapphire substrate, silicon carbide substrate, lithium tantalite substrate and the like have a high Mohs hardness and hence, cutting with the above cutting blade is not always easy. Since the cutting blade has a thickness of about 20 μm, the streets for sectioning devices needs to have a width of about 50 μm. Therefore, in the case of a device measuring about 300 μm×300 μm, the area ratio of the streets to the wafer is large, thereby reducing productivity.

As means of dividing a plate-like workpiece such as a semiconductor wafer, a laser beam processing method for applying a laser beam capable of passing through the workpiece with its focusing point on the inside of the area to be divided has been attempted and disclosed by JP-A 2002-192367, for example. In the dividing method using this laser beam processing technique, a workpiece is divided by applying a laser beam having an infrared range capable of passing through the workpiece with its focusing point on the inside from one surface side thereof to continuously form deteriorated layers along the dividing lines in the inside of the workpiece and then, exerting external force along the streets whose strength has been reduced by the formation of the deteriorated layers.

In the laser beam processing, the spot diameter of a laser beam is reduced as small as possible using a condenser having condenser lenses constituted by a set of condenser lenses to subject the workpiece to the micro-fabrication. When application of a laser beam is continued for a long time, however, the case housing the condenser becomes hot and the temperature of the case rises. As a result, a problem exists in that the case of the condenser thermally expands to dislocate the focusing point of the applied laser beam, thereby making it impossible to carry out the laser beam processing stably.

### SUMMARY OF THE INVENTION

It is an object of the present invention to provide a laser beam machine capable of carrying out stable laser beam processing without causing dislocation of the focusing point of a laser beam applied from a condenser even when laser beam processing is carried out continuously for a long time.

To attain the above object, according to the present invention, there is provided a laser beam machine comprising a workpiece holding means for holding a workpiece and a laser beam application means having a condenser for applying a laser beam to the workpiece held on the workpiece holding means, wherein
the machine further comprises a thermostatic means for maintaining the temperature of a case for housing the condenser lenses of the condenser constant.

The above thermostatic means comprises a cover member, which is arranged to surround the above condenser and forms a constant-temperature fluid passage between it and a peripheral wall of the case and a constant-temperature fluid supply means for supplying a constant-temperature fluid into the constant-temperature fluid passage.

In the present invention, since the laser beam machine has the thermostatic means for maintaining the temperature of the case for housing the condenser lenses of the condenser at a constant temperature, even when laser beam processing is carried out continuously for a long time, the thermal expansion of the case can be suppressed. Therefore, the laser beam machine of the present invention can carry out stable laser beam processing without causing dislocation of the focusing point of a laser beam applied from the condenser, even when the laser beam processing is carried out continuously for a long time.

### BRIEF DESCRIPTION OF THE DRAWINGS

FIG. 1 is a perspective view of a laser beam machine constituted according to the present invention;

FIG. 2 is a block diagram schematically showing the constitution of a laser beam application means provided in the laser beam machine shown in FIG. 1;

FIG. 3 is a block diagram showing the constitution of thermostatic means provided in the laser beam machine shown in FIG. 1;

FIG. 4 is a perspective view of a semiconductor wafer as a workpiece; and

FIG. 5 is a graph showing the dislocation of the focusing point according to the processing time of the laser beam machine.

### DETAILED DESCRIPTION OF THE PREFERRED EMBODIMENTS

A laser beam machine according to preferred embodiments of the present invention will be described in detail hereinunder with reference to the accompanying drawings.

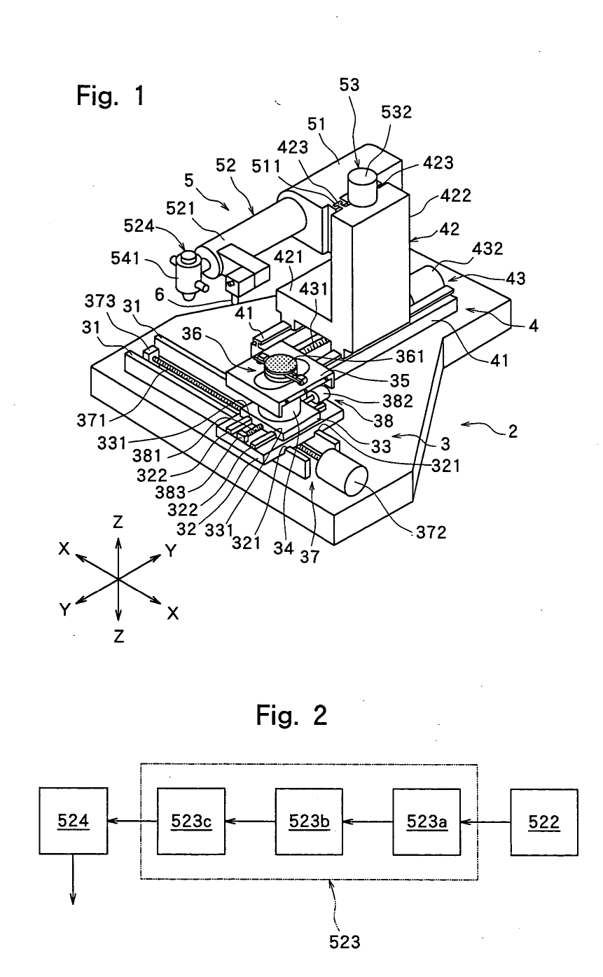

FIG. 1 is a perspective view of the laser beam machine constituted according to the present invention. The laser beam machine shown in FIG. 1 comprises a stationary base 2, a chuck table mechanism 3, which is mounted on the stationary base 2 in such a manner that it can move in a direction indicated by an arrow X and holds a workpiece, a laser beam application unit support mechanism 4 mounted on the stationary base 2 in such a manner that it can move in a direction indicated by an arrow Y perpendicular to the direction indicated by the arrow X, and a laser beam application unit 5, which is mounted on the laser beam application unit support mechanism 4 in such a manner that it can move in a direction indicated by an arrow Z.

The above chuck table mechanism 3 comprises a pair of guide rails 31 and 31, which are mounted on the stationary base 2 and arranged parallel to each other in the direction indicated by the arrow X, a first sliding block 32 mounted on the guide rails 31 and 31 in such a manner that it can move in the direction indicated by the arrow X, a second sliding block 33 mounted on the first sliding block 32 in such a manner that it can move in the direction indicated by the arrow Y, a support table 35 supported on the second sliding block 33 by a cylindrical member 34, and a chuck table 36 as a workpiece holding means. This chuck table 36 has an adsorption chuck 361 made of a porous material so that a disk-like semiconductor wafer as a workpiece is held on the adsorption chuck 361 by a suction means that is not shown. The chuck table 36 is rotated by a pulse motor (not shown) installed in the cylindrical member 34.

The above first sliding block 32 has, on its undersurface, a pair of to-be-guided guide grooves 321 and 321 to be fitted to the above pair of rails 31 and 31 and, on its top surface, a pair of guide rails 322 and 322 formed parallel to each other in the direction indicated by the arrow Y. The first sliding block 32 constituted as described above can move in the direction indicated by the arrow X along the pair of guide rails 31 and 31 by fitting the to-be-guided guide grooves 321 and 321 to the pair of guide rails 31 and 31, respectively. The chuck table mechanism 3 in the illustrated embodiment comprises a moving means 37 for moving the first sliding block 32 along the pair of guide rails 31 and 31 in the direction indicated by the arrow X. The moving means 37 includes a male screw rod 371 arranged between the above pair of guide rails 31 and 31 in parallel thereto, and a drive source such as a pulse motor 372 for driving the male screw rod 371. The male screw rod 371 is, at its one end, rotatably supported to a bearing block 373 fixed on the above stationary base 2 and is, at its other end, connected to the output shaft of the above pulse motor 372 via a speed reducer that is not known. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the direction indicated by the arrow X.

The above second sliding block 33 has, on its undersurface a pair of to-be-guided guide grooves 331 and 331 to be fitted to the pair of rails 322 and 322 provided on the top surface of the above first sliding block 32 and can move in the direction indicated by the arrow Y by fitting the to-be-guided guide grooves 331 and 331 to the pair of guide rails 322 and 322, respectively. The chuck table mechanism 3 in the illustrated embodiment has a moving means 38 for moving the second sliding block 33 in the direction indicated by the arrow Y along the pair of guide rails 322 and 322 provided on the first sliding block 32. The moving means 38 includes a male screw rod 381 that is arranged between the above pair of guide rails 322 and 322 in parallel thereto, and a drive source such as a pulse motor 382 for driving the male screw rod 381. The male screw rod 381 is, as its one end, rotatably supported to a bearing block 383 fixed on the top surface of the above first sliding block 32 and is, at its other end, connected to the output shaft of the above pulse motor 382 by a speed reducer that is not shown. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the direction indicated by the arrow Y.

The above laser beam application unit support mechanism 4 comprises a pair of guide rails 41 and 41 mounted on the stationary base 2 and arranged parallel to each other in the indexing-feed direction indicated by the arrow Y and a movable support base 42 mounted on the guide rails 41 and 41 in such a manner that it can move in the direction indicated by the arrow Y. This movable support base 42 comprises a movable support portion 421 movably mounted on the guide rails 41 and 41 and a mounting portion 422 mounted on the movable support portion 421. The mounting portion 422 is, on one of its flanks, provided with a pair of guide rails 423 and 423 extending in parallel to each other in the direction indicated by the arrow Z. The laser beam application unit support mechanism 4 in the illustrated embodiment comprises a moving means 43 for moving the movable support base 42 along the pair of guide rails 41 and 41 in the indexing-feed direction indicated by the arrow Y. This moving means 43 includes a male screw rod 431 arranged between the above pair of guide rails 41 and 41 in parallel thereto, and a drive source such as a pulse motor 432 for driving the male screw rod 431. The male screw rod 431 is, at its one end, rotatably supported to a bearing block (not shown) fixed on the above stationary base 2 and is, at its other end, connected to the output shaft of the above pulse motor 432 by a speed reducer that is not shown. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction indicated by the arrow Y.

The laser beam application unit 5 in the illustrated embodiment comprises a unit holder 51 and a laser beam application means 52 secured to the unit holder 51. The unit holder 51 has a pair of to-be-guided grooves 511 and 511 to be slidably fitted to the pair of guide rails 423 and 423 on the above mounting portion 422 and is supported in such a manner that it can move in the direction indicated by the arrow Z by fitting the to-be-guided guide grooves 511 and 511 to the above guide rails 423 and 423, respectively.

The illustrated laser beam application means 52 has a cylindrical casing 521 secured to the above unit holder 51 and extending substantially horizontally. In the casing 521, there are installed a laser beam oscillation means 522 and a laser beam modulation means 523 as shown in FIG. 2. A YAG laser oscillator or YVO4 laser oscillator may be used as the laser beam oscillation means 522. The laser beam modulation means 523 comprises a repetition frequency setting means 523a, a laser beam pulse width setting means 523b and a laser beam output setting means 523c. The repetition frequency setting means 523a, laser beam pulse width setting means 523b and laser beam output setting means 523c constituting the laser beam modulation means 523 may be known devices to people of ordinary skill in the art and therefore, detailed descriptions of their structures are omitted in this text. A condenser 524 housing condenser lenses (not shown) that are constituted by a set of condenser lenses and may be a known formation is attached to the end of the above casing 521.

A laser beam oscillated from the above laser beam oscillation means 522 reaches the condenser 524 through the laser beam modulation means 523. The repetition frequency setting means 523a of the laser beam modulation means 523 changes the laser beam into a pulse laser beam having a predetermined repetition frequency, the laser beam pulse width setting means 523b changes the pulse width of the pulse laser beam to a predetermined width, and the laser beam output setting means 523c sets the output of the pulse laser beam to a predetermined value.

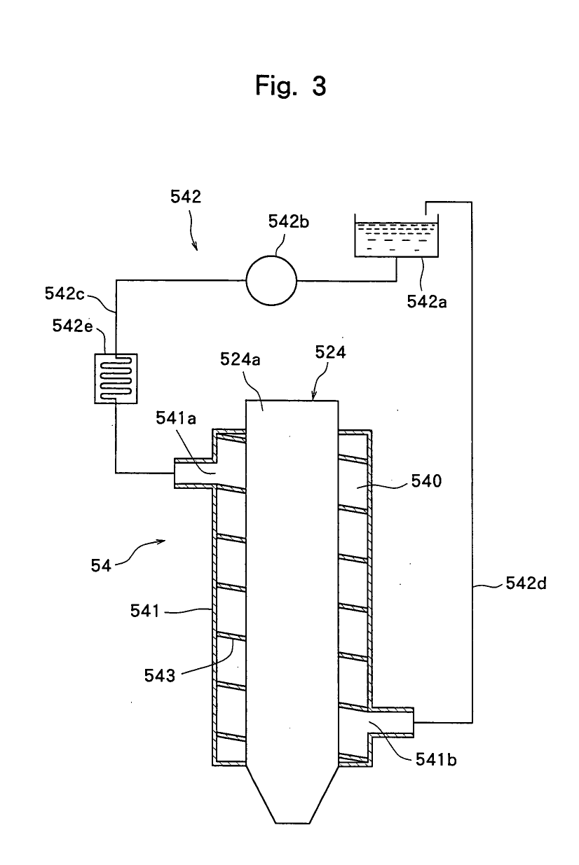

The laser beam machine shown in FIG. 1 comprises a thermostatic means 54 for maintaining the temperature of the case 524a of the condenser 524 constant as shown in FIG. 3. The thermostatic means 54 comprises a cover member 541, arranged to surround the case 524a of the condenser 524, for forming a constant-temperature fluid passage 540 between it and the peripheral wall of the case 524a and a constant-temperature fluid supply means 542 for supplying a constant-temperature fluid into the constant-temperature fluid passage 540. A constant-temperature fluid inlet port 541a which is open to the constant-temperature fluid passage 540 is formed in the upper part of the cover member 541 and a constant-temperature fluid outlet port 541b which is open to the constant-temperature fluid passage 540 is formed in the lower part of the cover member 541. A spiral guide plate 543 is installed in the cover member 541 to form the constant-temperature fluid passage 540 as a spiral passage.

The constant-temperature fluid supply means 542 shown in FIG. 3 is so constituted as to supply constant-temperature water as the constant-temperature fluid in a water tank 542a into the constant-temperature fluid passage 540 from the constant-temperature fluid inlet port 541a through a pipe 542c by a pump 542b. The constant-temperature fluid flown into the constant-temperature fluid passage 540 acts on the peripheral wall of the case 524a of the condenser 524 to effect heat exchange and is returned to the water tank 542a from the constant-temperature fluid outlet port 541b through a pipe 542d. In the embodiment shown in FIG. 3, the pipe 542c is provided with a heat exchanger 542e for cooling constant-temperature water supplied by the pump 542b. The constant-temperature fluid supply means 542 thus constituted supplies, for example, constant-temperature water having a temperature of 23° C. into the constant-temperature fluid passage 540. The constant-temperature fluid supply means 542 shown in FIG. 3 supplies constant-temperature water as the constant-temperature fluid but other liquid or gas such as helium or nitrogen having high air thermal conductivity may be used as the constant-temperature fluid.

Returning to FIG. 1, an image pick-up means 6 is situated at the front end of the casing 521 constituting the above laser beam application means 52. This image pick-up means 6 in the illustrated embodiment comprises an infrared illuminating means for applying infrared radiation to the workpiece, an optical system for capturing infrared radiation applied by the infrared illuminating means, and an image pick-up device (infrared CCD) for outputting an electric signal corresponding to infrared radiation captured by the optical system, in addition to an ordinary image pick-up device (CCD) for taking an image with visible radiation. An image signal is transmitted to a control means that is not shown.

The laser beam application unit 5 in the illustrated embodiment comprises moving means 53 for moving the unit holder 51 along the pair of guide rails 423 and 423 in the direction indicated by the arrow Z. The moving means 53 comprises a male screw rod (not shown) arranged between the pair of guide rails 423 and 423 and a drive source such as a pulse motor 532 for driving the male screw rod, like the above-mentioned moving means. By driving the male screw rod (not shown) in a normal direction or reverse direction with the pulse motor 532, the unit holder 51 and the laser beam application means 52 are moved along the guide rails 423 and 423 in the direction indicated by the arrow Z.

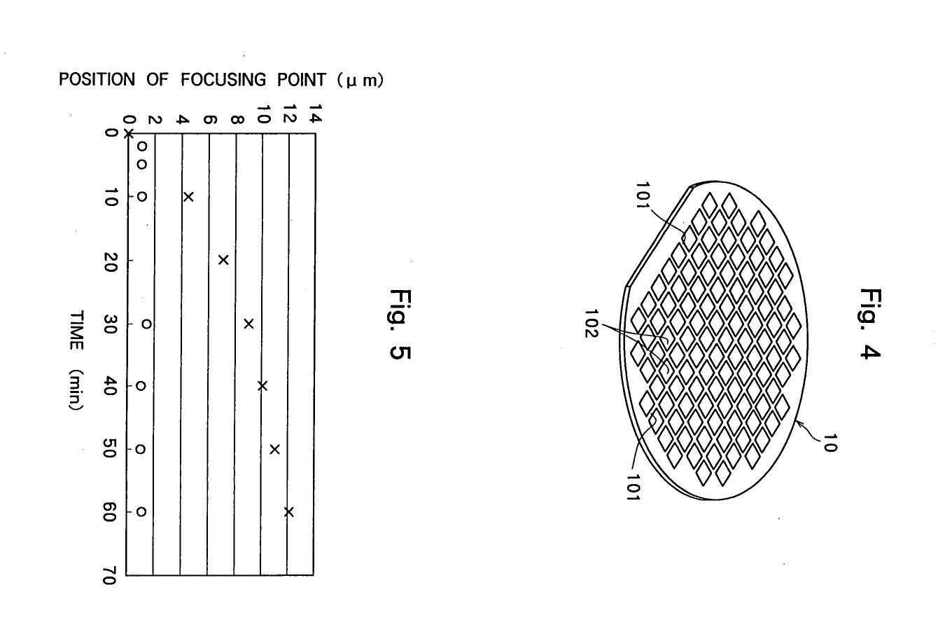

The laser beam machine in the illustrated embodiment is constituted as described above, and its operation of processing the semiconductor wafer 10 shown in FIG. 4 will be described hereinbelow.

In the semiconductor wafer 10 shown in FIG. 4, a plurality of areas are sectioned by a plurality of streets 101 formed in a lattice pattern on the front surface, and a circuit 102 such as IC, LSI or the like is formed in each of the sectioned areas. The semiconductor wafer 10 thus constituted is suction-held on the chuck table 36 in such a manner that the back surface faces up. The chuck table 36 suction-holding the semiconductor wafer 10 is moved along the guide rails 31 and 31 by the operation of the moving means 37 and positioned right below the image pick-up means 6 mounted on the laser beam application unit 5.

After the chuck table 36 is positioned right below the image pick-up means 6, image processing such as pattern matching is carried out to align a street 101 that is formed on the semiconductor wafer 10 held on the chuck table 36, with the condenser 524 of the laser beam application means 52 for applying a laser beam along the street 101 by the image pick-up means 6 and a control means that is not shown, thereby performing the alignment of a laser beam application position. Although the surface, on which the street 101 is formed, of the semiconductor wafer 10 faces down at this point, an image of the street 101 can be taken from the back surface as the image pick-up means 6 is constituted by an infrared illuminating means, an optical system for capturing infrared radiation and an image pick-up device (infrared CCD) for outputting an electric signal corresponding to the infrared radiation as described above.

After the street 101 formed on the semiconductor wafer 10 held on the chuck table 36 is detected and the alignment of the laser beam application position is carried out, the chuck table 36 is moved to a laser beam application range where the condenser 524 of the laser beam application unit 5 for applying a laser beam is located, and a laser beam is applied along the street 101 of the semiconductor wafer 10 from the condenser 524 of the laser beam application means 52. At this point, the laser beam is applied with its focusing point on the inside, that is, near the front surface (surface on the underside), through the back surface (surface on the topside) of the semiconductor wafer 10 thereby forming a deteriorated layer along the street 101 in the inside of the semiconductor wafer 10. If the focusing point dislocates by several μm or more, desired processing cannot be made.

The above laser beam processing conditions will be described hereinbelow.

The chuck table 36 is moved in the direction indicated by the arrow X (see FIG. 1) at a predetermined feed rate (for example, 100 mm/sec) while a pulse laser beam is applied to a predetermined street 101 from the condenser 524 of the laser beam application means 52, from the back surface of the semiconductor wafer 10. The following infrared laser beam is used as the laser beam.
Light source: Nd:YVO4 pulse laser
Wavelength: 1,064 nm
Pulse energy: 10 μJ
Repetition frequency: 100 kHz
Pulse width: 40 ns
Focusing spot diameter: 1 μm
Energy density of focusing point: 3.2×10E10W/cm².

By thus carrying out the above processing, the deteriorated layers are formed along all the streets 101 formed on the semiconductor wafer 10. During laser beam processing, constant-temperature water having a temperature of, for example, 23° C. is circulated through the constant-temperature fluid passage 540 formed around the case 524a of the condenser 524 by the operation of the pump 542b of the constant-temperature fluid supply means 542.

In the laser beam processing, the condenser 524 housing condenser lenses that are constituted by a set of condenser lenses for applying a laser beam becomes hot and the temperature of the case 524a rises. FIG. 5 is a graph showing the dislocation of the focusing point caused by a rise in the temperature of the case 524a with the passage of the laser beam processing time. In FIG. 5, the laser beam processing time is shown on the horizontal axis, the position of the focusing point is shown on the vertical axis, the mark X is a plot for the position of the focusing point of the conventional laser beam machine, and the mark ∘ is a plot for the position of the focusing point of the laser beam machine equipped with the above thermostatic means 54. In FIG. 5, when the laser beam processing time was 0, the temperature of the case of the condenser was 23° C. As shown by the mark X in FIG. 5, in the convention laser beam machine, as the laser beam processing time becomes longer, the focusing point dislocates larger. It is understood that when laser beam processing was continued for 60 minutes, the focusing point dislocated by 12 μm. At this time, the temperature of the case of the condenser was 30° C. In contrast to this, in the laser beam machine equipped with the above thermostatic means 54, as shown by the mark ∘, even when the laser beam processing time was long, the dislocation of the focusing point was maintained at about 1 μm. The figure “±1 μm” is a measurement error range, and the position of the focusing point at the start of processing is substantially maintained. Thus, even when the laser beam processing is continued for a long time, the position of the focusing point at the start of processing is maintained because the laser beam machine comprises the thermostatic means 54. Therefore, stable high-precision laser beam processing can be ensured.

1. A laser beam machine comprising a workpiece holding means for holding a workpiece and a laser beam application means having a condenser for applying a laser beam to the workpiece held on the workpiece holding means, wherein
the machine further comprises a thermostatic means for maintaining the temperature of a case for housing the condenser lenses of the condenser constant.

2. The laser beam machine according to claim 1, wherein the thermostatic means comprises a cover member that is arranged to surround the condenser and forms a constant-temperature fluid passage between it and the peripheral wall of the case and a constant-temperature fluid supply means for supplying a constant-temperature fluid into the constant-temperature fluid passage.
